(19) United States
(12) Patent Application Publication
(10) Pub. No.: US 2012/0096386 A1
(43) Pub. Date: Apr. 19, 2012

(54) USER INTERFACE FOR APPLICATION TRANSFERS

(76) Inventors: LAURENT BAUMANN, Campbell, CA (US); Daniel I. Feldman, San Francisco, CA (US); Jean-Pierre Ciudad, San Francisco, CA (US); John Louch, San Louis Obispo, CA (US); Chris Ryan, Windham, NH (US); Erika Misaki, San Francisco, CA (US)

(21) Appl. No.: 13/009,778

(22) Filed: Jan. 19, 2011

Related U.S. Application Data
(60) Provisional application No. 61/394,761, filed on Oct. 19, 2010.

(51) Int. Cl. G06F 3/048

(52) U.S. Cl. 715/772

(57) ABSTRACT

Methods, systems and machine readable tangible storage media that provide a user interface to an application store. In one embodiment, an icon representing an application being transferred to a user device appears to fly across the display area during the download and installation of the application before landing on a dock or other program control area from which the application can subsequently be launched. The user device synchronizes the flight of the icon with the progress of the download and installation by tracking the progress in communication with the server from which the application was transferred. The appearance of flight can be both vertical and horizontal and the icon bounces after the download and installation is complete conveying to the user that the application is ready to launch. The appearances of the locations from which the icon begins and ends its journey are changed to enhance the simulation of flight. Other embodiments are also described.

### CROSS-REFERENCE TO RELATED APPLICATIONS

This application claims the benefit of an earlier filed provisional application, Application Ser. No. 61/394,761 filed on Oct. 19, 2010 entitled USER INTERFACE FOR APPLICATION TRANSFERS.

### BACKGROUND OF THE INVENTION

Modern data processing systems, such as a Macintosh computer running the Macintosh operating system, or a mobile computing device, such as an iPhone running the mobile operating system iOS, allow the user to purchase an application online for immediate download and installation. Tracking the progress of the download and installation can be a distraction, however, and does not provide sufficient information to the user as to when the application is ready to launch on their system or device.

### SUMMARY OF THE DESCRIPTION

Methods, machine readable tangible storage media, and data processing systems that can present a user with available applications to purchase for use with a document on their data processing system or mobile computing device are described. In the description that follows, a data processing system or mobile computing device are collectively referred to as a user device, and a file which may be a document or other type of data or content, such as a word processing document, spreadsheet, PDF file or media file, etc. is simply referred to as a document.

In one embodiment, after receiving approval of a purchase or transfer of an application using an interface to an application server, a user device conveys the progress of downloading and installing the application by animating an icon representing the application to appear to fly across the display area of the user device, from a starting location to a destination location.

In one embodiment, the starting location may be an application store interface to an application store server in communication with the device, the application store server having a plurality of applications available for purchase or transfer to the device. In another embodiment, the starting location may be an interface to a file system maintained by the user device or on another server in communication with the user device, the file system having files that include applications, documents, or other types of data or content, such as a word processing document, spreadsheet, PDF file or media file, etc.

In one embodiment, the destination location may be a program control area of the display area of the user device, the program control area being an area from which the application may be launched after completing download and installation. The program control area can be, for example, the dock on a user device using the Macintosh operating system, or a task bar on a user device using the Windows operating system, or a control area such as the springboard displayed on the iPhone.

In one embodiment, an agent on the user device, such as an application store agent in communication with an application store server, tracks the purchase or transfer, download and installation of the application on the user device to facilitate synchronizing the icon's appearance of flight from the starting location to the destination location with the respective commencement, progress, and completion of download and installation.

In one embodiment, during download and installation of the application the icon can be animated by altering any one or more of the position, transparency and size or other characteristics of the icon to achieve the appearance of flight, including the appearance of one or more of vertical and horizontal flight. In addition, the appearance of the starting location and destination location can be altered to enhance the appearance of flight of the icon relative to the purchase and destination locations. For example, the appearance of the locations may be altered by changing one or more of the transparency, contrast, size or other characteristic of one or both of the locations.

In one embodiment, the appearance of the icon can be altered to signify the completion of the download and installation by appearing to land or ending flight when arriving at the destination location. The completion of the download and installation may be further conveyed to the user by making the icon appear to bounce on the destination location upon landing.

In one embodiment, the progress of the download and installation may be further conveyed to the user by displaying a progress bar at or near the destination location. The progress bar can be subdivided to distinguish between the download portion of progress and the installation portion of progress. The progress bar typically appears upon or after the arrival of the icon at or near the destination location, and can be removed from the destination location upon the completion of the download and/or installation.

The above summary does not include an exhaustive list of all aspects of the present invention. It is contemplated that the invention includes all systems and methods that can be practiced from all suitable combinations of the various aspects summarized above, and also those disclosed in the Detailed Description below.

### BRIEF DESCRIPTION OF THE DRAWINGS

The present invention is illustrated by way of example and not limitation in the figures of the accompanying drawings in which like references indicate similar elements.

FIG. 1 is a is a block diagram of a system for an user interface for application transfers in a data processing system or mobile computing device according to one embodiment of the present invention.

FIG. 2 shows an example of a display area of a user device illustrating a user interface for application transfers which can be provided according to a system shown in FIG. 1, and in accordance with an embodiment of the present invention.

FIGS. 3A-3D show example screen shots of a display area of a user device illustrating a user interface for application purchases which can be provided according to a system shown in FIG. 1, and in accordance with an embodiment of the present invention.

FIG. 4 shows another example of a display area of a user device illustrating a user interface for application transfers which can be provided according to a system shown in FIG. 1, and in accordance with an embodiment of the present invention.

FIGS. 5A-5D show another example of screen shots of a display area of a user device illustrating a user interface for application transfers which can be provided according to a system shown in FIG. 1, and in accordance with another embodiment of the present invention.

FIGS. 6 and 7 are flowcharts showing methods according to embodiments of the present invention.

FIG. 8 shows, in block diagram form, an example of a data processing system which can be used with one or more embodiments described herein.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Inc. 2011.

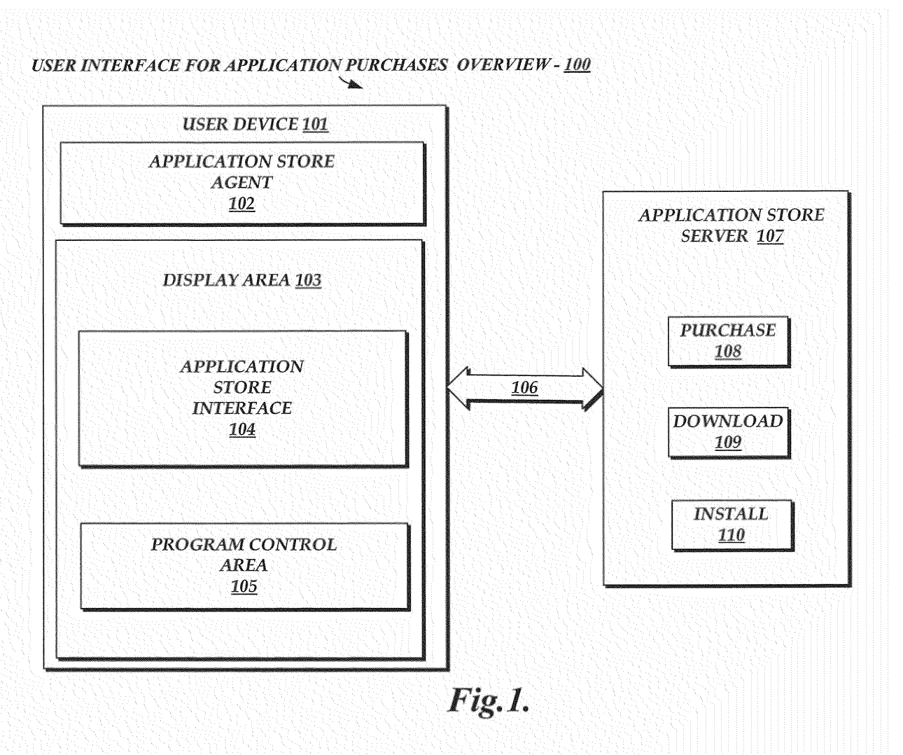

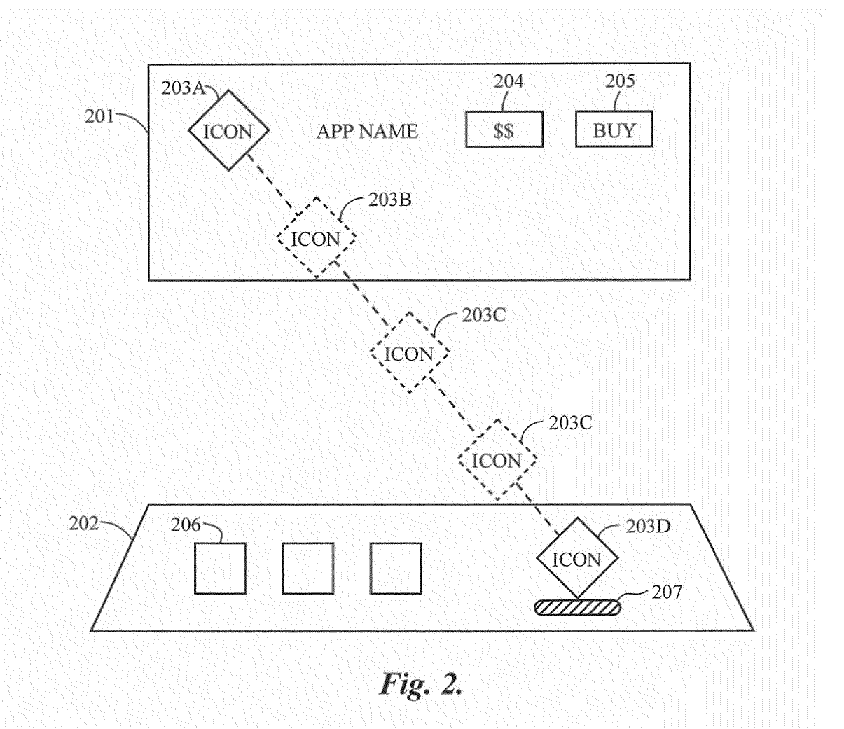

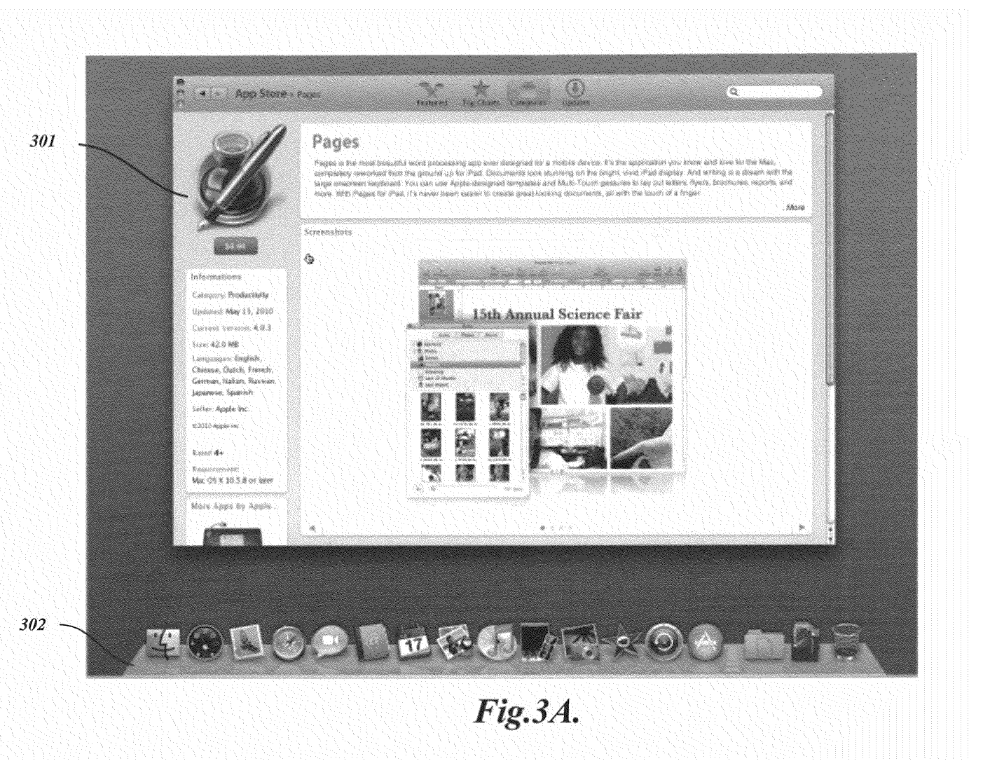

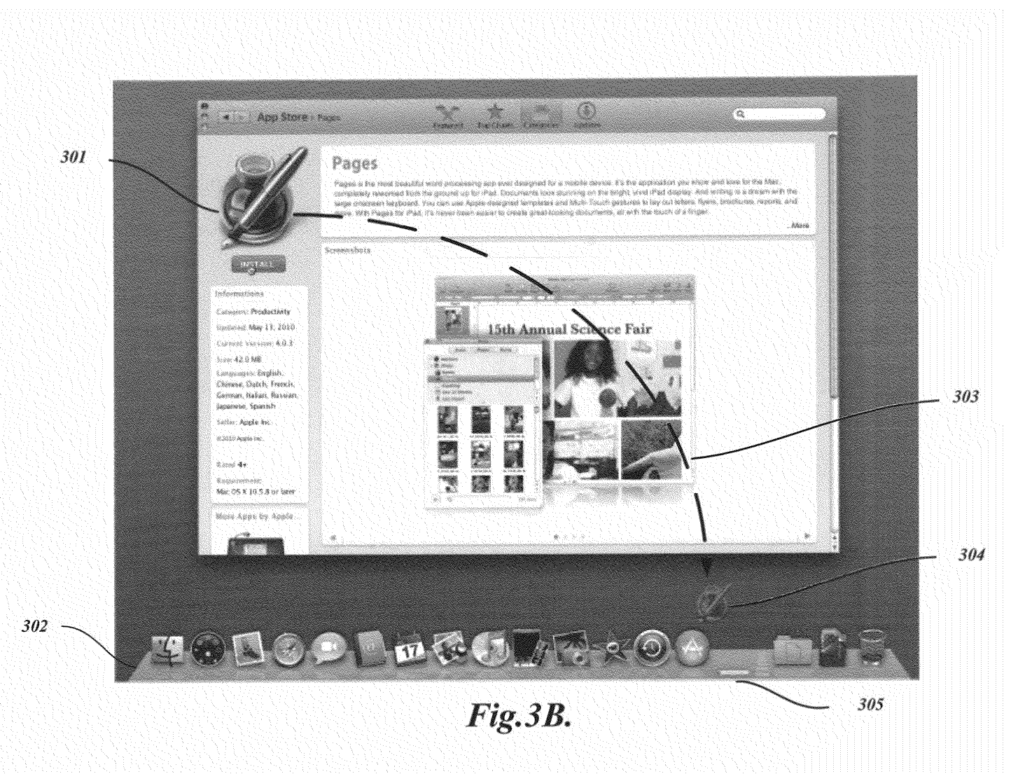

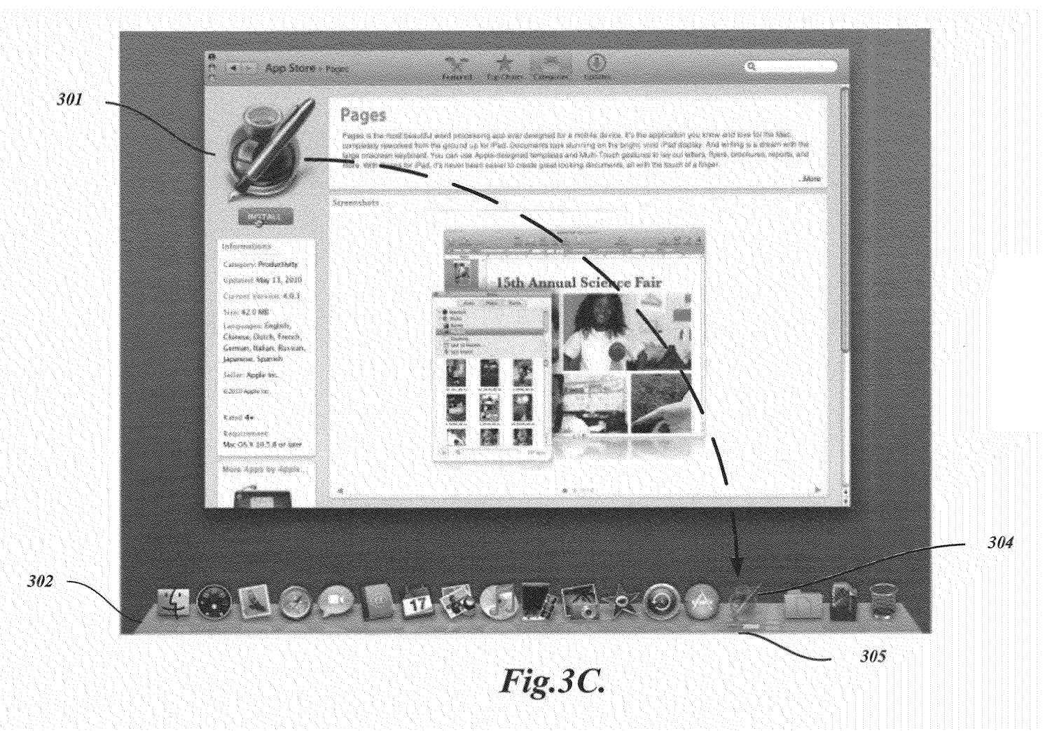

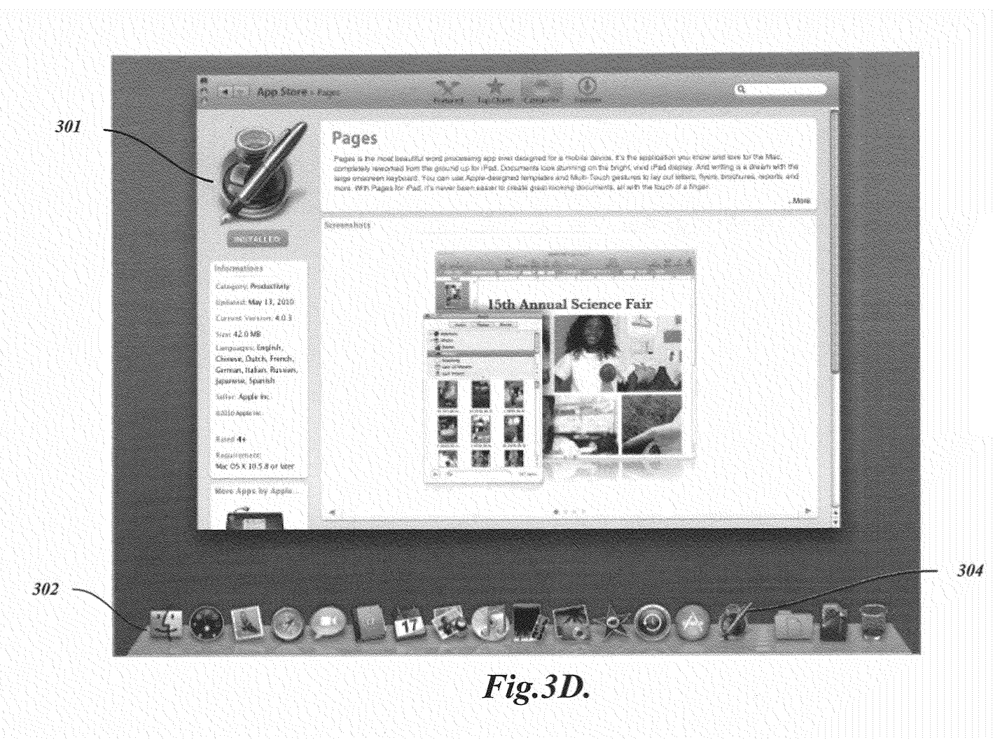

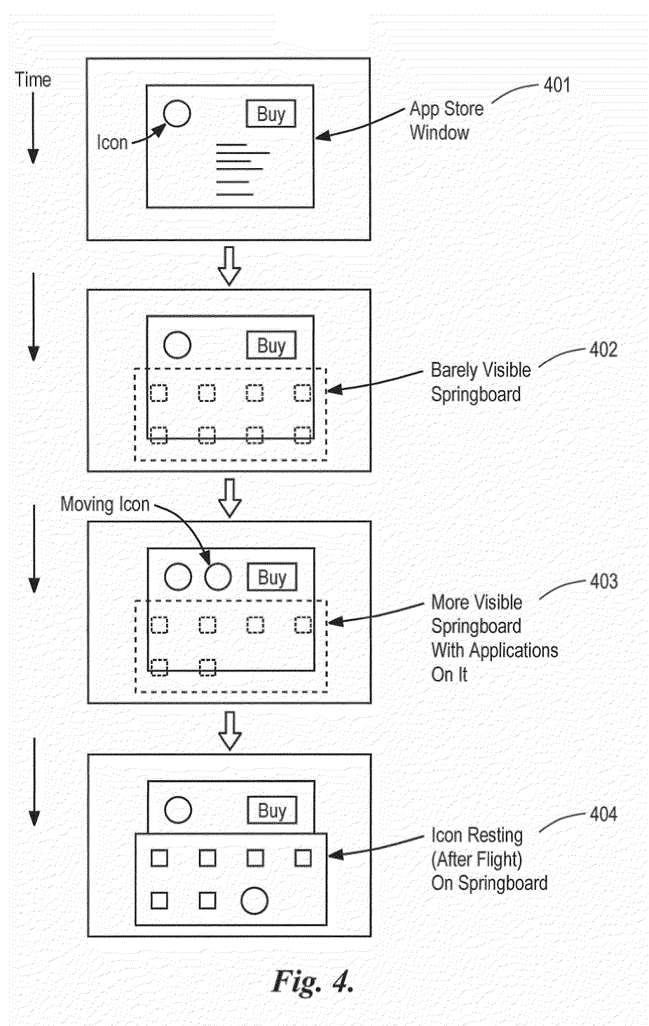

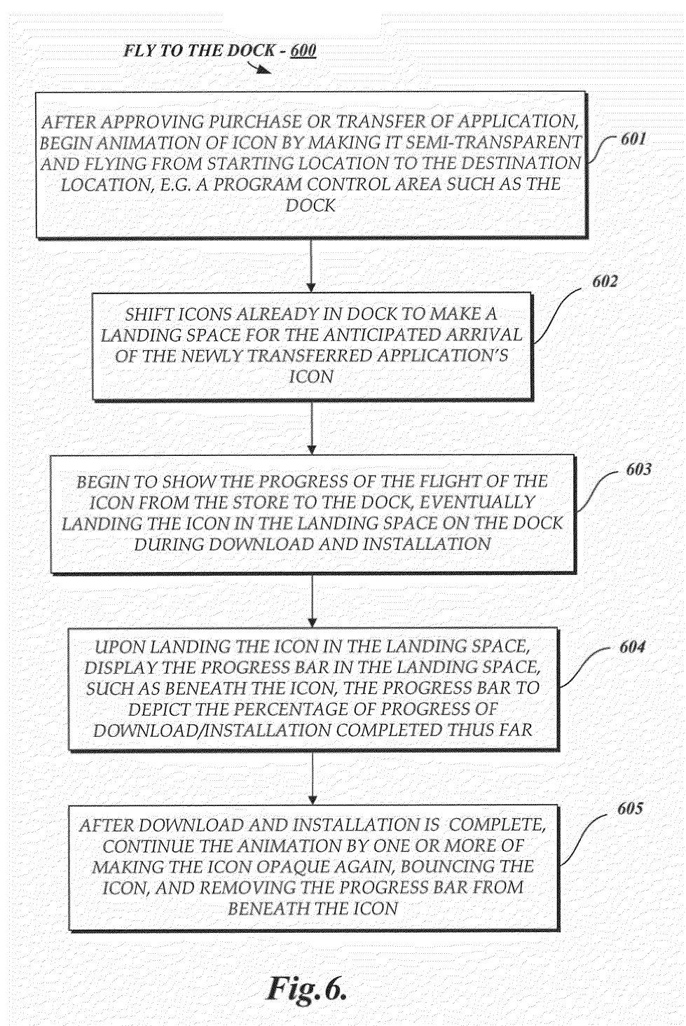

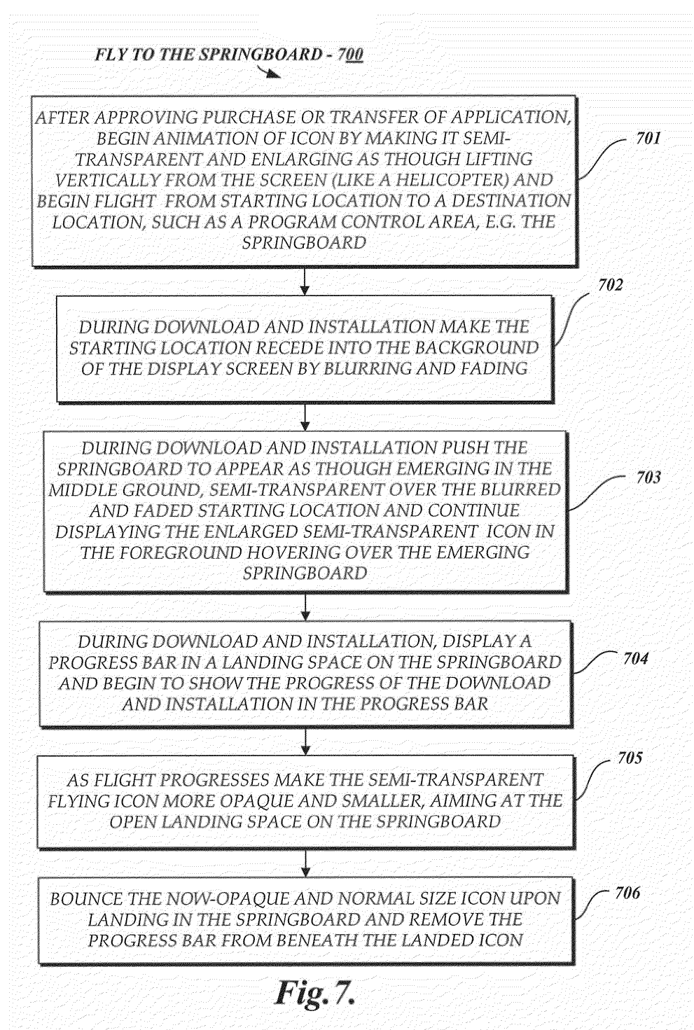

FIG. 1 shows a block diagram overview of a system 100 according to one embodiment of the present invention for a user interface for application transfers in a user device. Examples of user interfaces that can be implemented according to this system are provided in FIGS. 2, 3A-3D as well as FIG. 4, 5A-5D. Examples of methods that can be implemented according to this system are provided in FIGS. 6 and 7.

The system 100 includes a user device 101 that includes a data processing system, such as a laptop or desktop computer running an operating system, such as the Macintosh or Windows operating system, or a mobile computing device, such as an iPhone, iPod Touch, or iPad running a mobile operating system, such as the iOS operating system. The user device 101 has an interface to an application server that has applications available for purchase or transfer, such as an application store interface 104 to access an application store server 107. The user device 101 is further equipped with a display area 103, that includes an area visible to the user and in some cases operable by the user by touch. During operation of the user device 101, the display area 103 can include the interface to the application store server, such as the application store interface 104. The display area can further include an application or document control area, also referred to as a program control area 107 such as the dock generated by the Macintosh operating system, or the desktop area presented by the Windows operating system, such as provided in Windows 7 (from Microsoft Corporation of Redmond, Wash.) with the start menu or task bar in Windows 7 at the corner of a display screen; the activation of the start menu can produce a list of programs by program name and/or icon which is similar to the dock. Alternatively, the program control area 107 can be a springboard area such as generated by the mobile operating system iOS and displayed on the iPhone.

In one embodiment, during operation of the system, the user device 101 receives an indication that an application is ready for transfer, such as upon approval of a purchase 108 of an application from the application store server 107 via the application store interface 104 that is displayed on the user device display area 103. The user device 101 initiates a process 106, such as a background process to communicate with the application store server 107 to monitor the download 109 and installation 110 services for tracking the download and installation of the application from the application store server 107 to the user device 101.

FIG. 2 illustrates an exemplary application store interface 201 that can be used to conduct a purchase or otherwise initiate a transfer of an application from the application store server 107 to the user device 101. The interface 201 lists the application by name with an icon representing the application 203A and corresponding price 204 and buy 205 buttons. After receiving approval of the purchase or transfer of the application, the user device 101 causes the display of the icon representing the application 203A to move across the display area 103 of the user device 101 from its starting location at 203A, to a destination location, here illustrated as location within a dock 202. In preparation for receiving the application and displaying the icon 203A representing the application in the destination location, the other icons 206 already residing on the dock 202 are shifted to make room; in the illustrated example they would be shifted to the left.

In one embodiment, the icon 203A moves as can be seen in the illustration in FIG. 2, from left to right and downward, passing through intermediary locations 203B and 203C before coming in to rest or land on the dock 202 at 203D. In one embodiment, a progress bar 207 is placed beneath the location 203D where the icon is to land, typically upon the icon 203A coming in to rest or land on the dock 202 at 203D. The progress bar 207 is filled up to reflect the progress of download and installation. For example, if by the time the icon 203A lands on the dock 202 fifty percent of the download is complete, then the progress bar 207 appears halfway filled to reflect the progress of the download. In one embodiment, the progress bar 207 may be subdivided into two portions, one representing the progress of the download, and one representing the progress of the installation. In a typical scenario, the icon 203A lands on the dock 202 while the download occurs, and the remaining progress of the download is reflected in the progress bar 207 until the completion of the downloading and installation.

In one embodiment, the icon 203A bounces after landing on the dock 202 to signify the completion of the downloading and installation. In a typical embodiment, once the downloading and installation is complete, the progress bar 207 is completely filled in and immediately removed from the dock 202, and the icon 203A bounces upon removal of the progress bar 207 from the dock. In one embodiment, the appearance of the icon 203A changes to opaque upon the completion of the installation alternatively or in addition to bouncing.

FIGS. 3A-3D are screenshots of a display area 103 on the user device 101 in which an embodiment of the invention has been implemented. As illustrated, in FIG. 3A, the display area 103 includes an application store interface 104 such as the App Store™ owned and operated by Apple, Inc. The App Store displays an application named Pages and includes an icon representing the Pages application, here an inkwell and pen. The display area 103 also includes a program control area 105 such as the dock 302, on which are displayed several icons for applications already installed on the user device 101.

FIG. 3B shows the icon 301 taking flight along the path 303 of the dotted line and positioned near the dock just above the destination location 304 where it is going to land. As shown, the icon's appearance is changed during flight to be semi-transparent to enhance the appearance of flight over the display area 103. Notice that in preparation for receiving the new icon 301, the dock 302 has shifted the existing icons displayed therein to the left to make room for the new icon. In one embodiment, the user device 101 also displays in the dock 302 beneath the location where the new icon 301 is to land, a progress bar 305 that is filled in synchronization with the tracking of the download and installation processes by the application store agent 102 operating on the user device 101.

FIG. 3C shows the icon 301 having landed at the destination location 304 in the dock 302. The progress bar 305 is shown as halfway filled conveying to the user that at least the download of the application is completed. The icon 301 position at location 304 remains semi-transparent because the installation is not yet complete.

FIG. 3D illustrates the display area 103 showing the appearance of the icon 301 at location 304 having changed to opaque and the absence of the progress bar 305 in the previous figures. This conveys to the user of the user device 101 that the application has been completely downloaded and installed and is ready for launch from the dock 302. In one embodiment, the now opaque icon 301 is bounced at location 304 to further signify the completion of the download and installation and that the application is ready for launch from the dock 302.

FIG. 4 illustrates an example of a series of display areas 103 on a user device 101 over time to demonstrate the user interface for application transfer when using a destination location that is a springboard, such as the springboard available in the mobile device operating system iOS. As shown in the series of application store windows 401, 402, 403, 404 that represent the changing appearance of the display area 103 over time, the icon representing the application being purchased or transferred is gradually moved from a starting location at the upper left hand corner of the display at the same time as the springboard gradually pushes through to the foreground of the display area 103. As the springboard becomes more visible, the icon moves into position to a destination location on the springboard until finally landing on the springboard. The landing of the icon on the springboard is synchronized with the completion of the download and installation of the application that the icon represents. In one embodiment, the synchronization occurs in coordination with the tracking and monitoring by the application store agent 102 in communication with the application store server 107 of the download 109 and install 110 services using a background process 106.

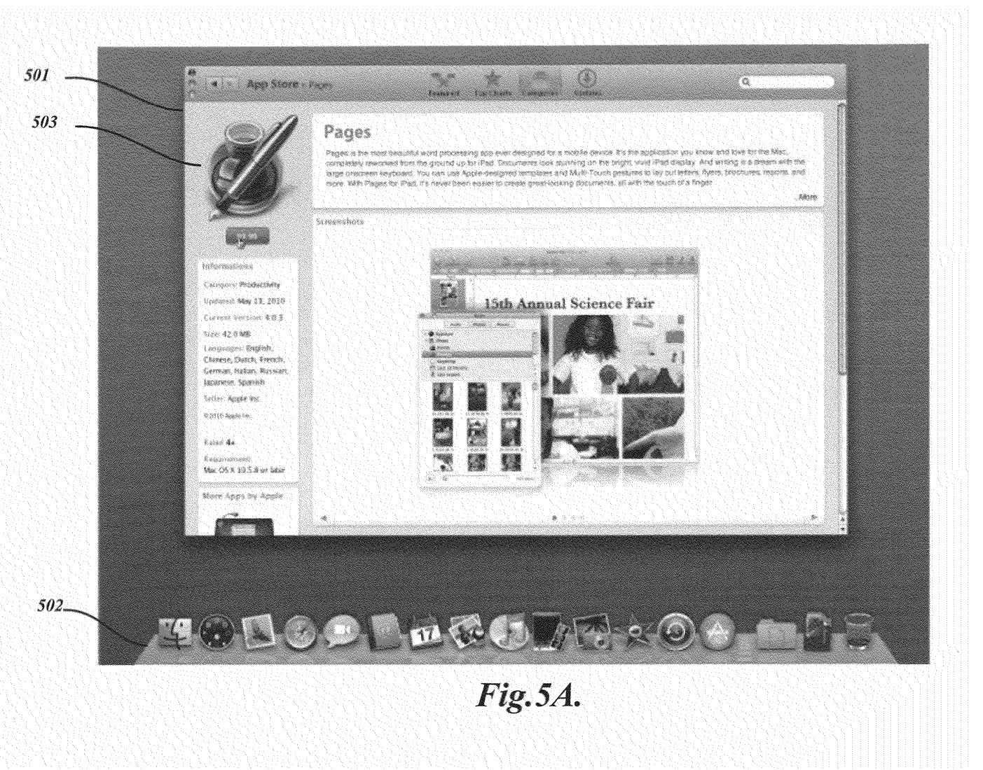

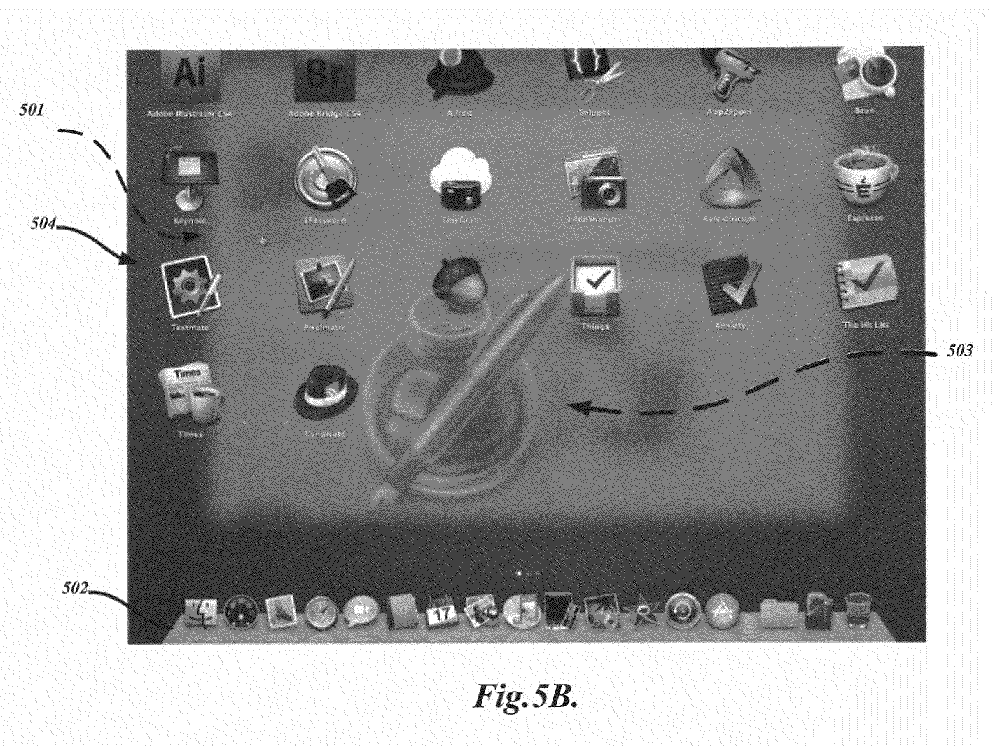

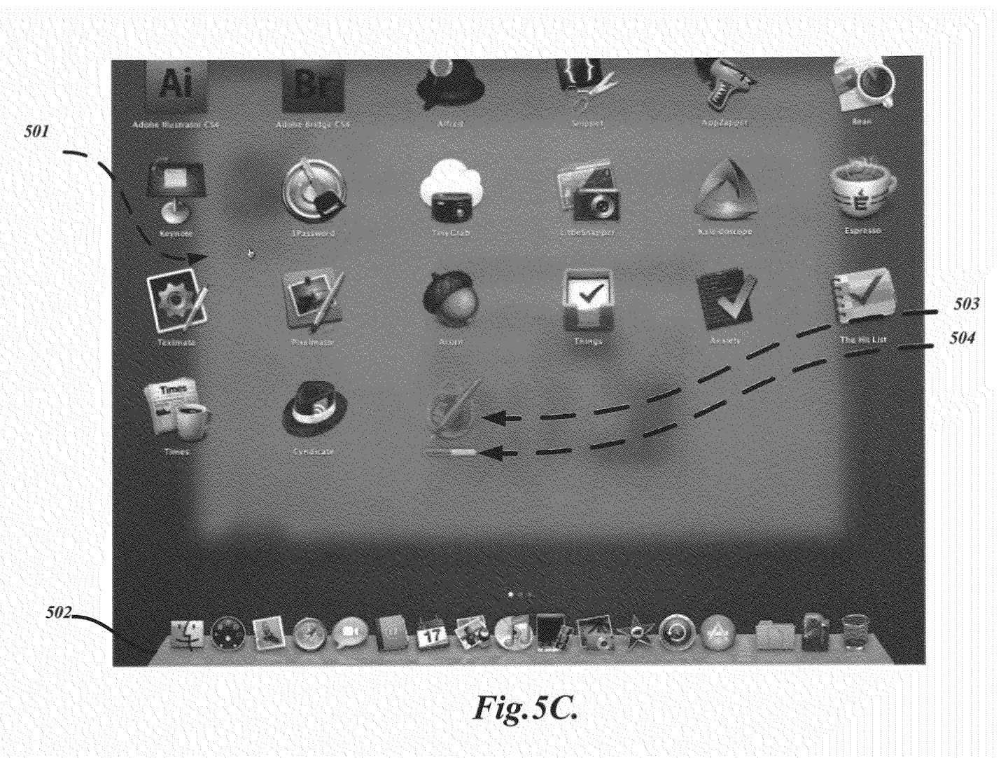

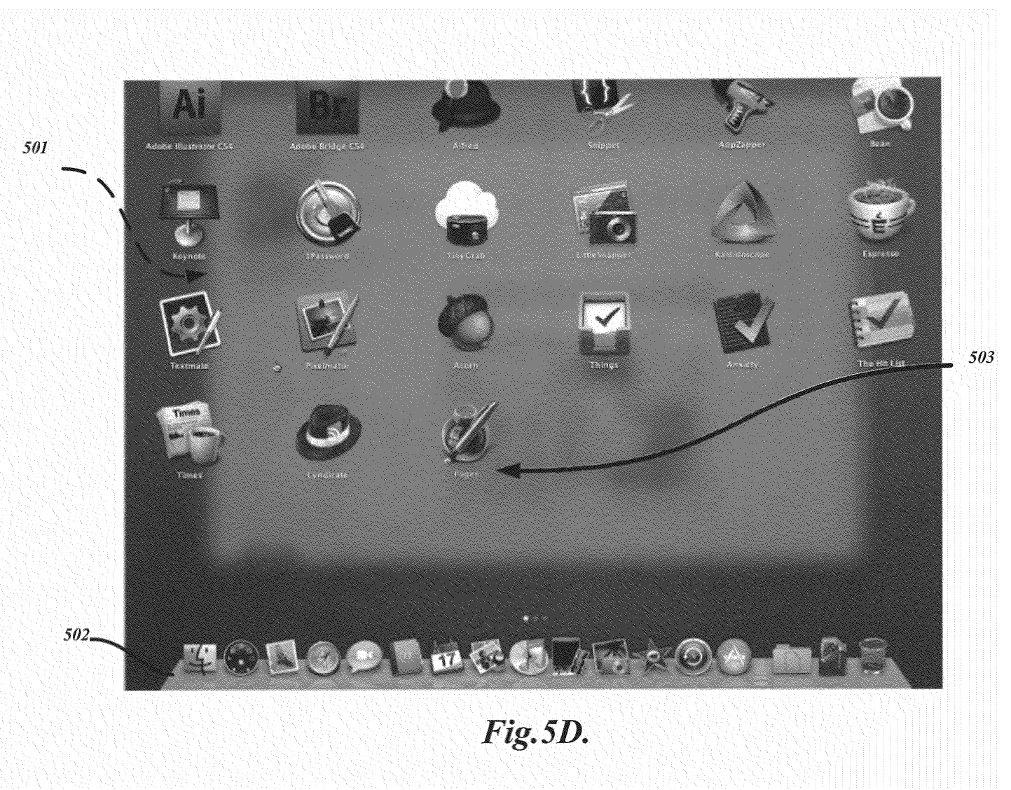

FIGS. 5A-5D are screenshots of a display area 103 on the user device 101 in which another embodiment of the invention has been implemented. As shown in FIG. 5A, an application store interface 104 such as the App Store 501 owned and operated by Apple, Inc., appears on the display area 103 of the user device 101, along with a dock 502. This time, however, instead of flying to the dock 502 to convey to the user the progress of the download and installation of the application represented by the icon 503, the icon 503 flies to a springboard 504, illustrated in FIG. 5B, that begins to push through to the middle ground of the display area 103, obscuring the underlying App Store 501 which now is in the background, its details blurred.

In one embodiment, while the springboard is emerging into view, the icon 503 meanwhile stays in the foreground and can be enlarged and made semi-transparent, as shown in FIG. 5B, giving the appearance of vertical and horizontal flight, like a helicopter pulling away from a helipad. The icon 503 hovers over an area of the springboard that becomes the destination location for the icon 503 once the download and installation of the application is complete.

FIG. 5C illustrates, in one embodiment, the addition to the springboard destination location of a progress bar 504 beneath the icon 503. As in the previous example, the progress bar 305 is filled in synchronization with the tracking of the download and installation processes by the application store agent 102 operating on the user device 101. As shown in FIG. 5D, the absence of the progress bar, indicates that the download and installation is complete. In one embodiment, the icon 503 is made opaque as well, further conveying to the user that the download and installation is complete and that the application is ready to launch. In one embodiment, the icon 503 is made to bounce as well, further conveying to the user that the download and installation is complete and that the application is ready to launch. Throughout the download and installation process, the original application store interface 501 and starting location of the icon 503 can remain in the display area 103 partially visible to the user.

Turning now to a flowchart in FIG. 6, in which a method 600 implements the system for a user interface for application transfer beginning at process 601, after approving an application for purchase or transfer, the method makes the icon representing the application semi-transparent and flies it from the starting location to the destination location in synchronization with tracking the progress of the download and installation. At process 602, the method 600 continues by shifting icons already in the destination location to make a landing space for the anticipated arrival of the newly transferred application's icon. At process 603, the method 600 continues by beginning to show the progress of the flight of the icon, and eventually landing the icon in the landing space on the dock during download and installation. At process 604, upon landing the icon in the landing space, the method 600 continues by displaying a progress bar in the landing space beneath the landed icon to further convey to the user the progress of the download and installation of the application. If, for example, by the time the icon lands fifty percent of the application is downloaded, then the method 600 displays the progress bar at fifty percent filled. At process 605, after download and installation is finally complete, the method 600 can optionally continue the animation of the icon by removing the progress bar and/or making the icon fully opaque. Lastly, in one embodiment, at process 605, the method 600 concludes by bouncing the icon at the destination location, or dock, after download and installation is finally complete, alternatively or in addition to changing the appearance of the icon to be fully opaque. The absence of the progress bar, opacity of the icon, and/or bouncing of the icon, convey to the user that the download and installation is complete and the application is ready to launch.

FIG. 7 is a flowchart illustrating another embodiment of the system for a user interface for application transfer beginning at process 701, where this time, the user device 101 enlarges the icon in addition to making it semitransparent to simulate vertical flight from the starting location on the display area as the application interface at process 701 fades into the background. The icon is moved upward and toward the destination location on the springboard at process 703 as the springboard begins to emerge into the middle ground of the display area but semi-transparent so that the faded application interface from which the icon began its journey is still visible. The icon hovers over the springboard above the destination location where it is to land, and the method 700 continues at process 704 a progress bar can be added to the springboard as before, to further convey to the user the progress of the download and installation. The method 700 continues at process 705 in which the appearance of the icon changes in preparation for landing, becoming more opaque and smaller, aiming at the destination location of the open landing space. At process 706 the method 700 concludes when the icon lands on the springboard, after which the download and installation are completed and the appearance of the icon is returned to an opaque state. In one embodiment, the icon appears to bounce on the springboard to signify completion of the download and installation, and to indicate that the application is ready to launch. The method 700 concludes by removing the progress bar from the display after the completion of the download and installation as it is no longer necessary.

Any one of the methods described herein can be implemented on a variety of different data processing devices, including general purpose computer systems, special purpose computer systems, etc. For example, the data processing systems which may use any one of the methods described herein may include a desktop computer or a laptop computer or a tablet computer or a smart phone, or a cellular telephone, or a personal digital assistant (PDA), an embedded electronic device or a consumer electronic device.

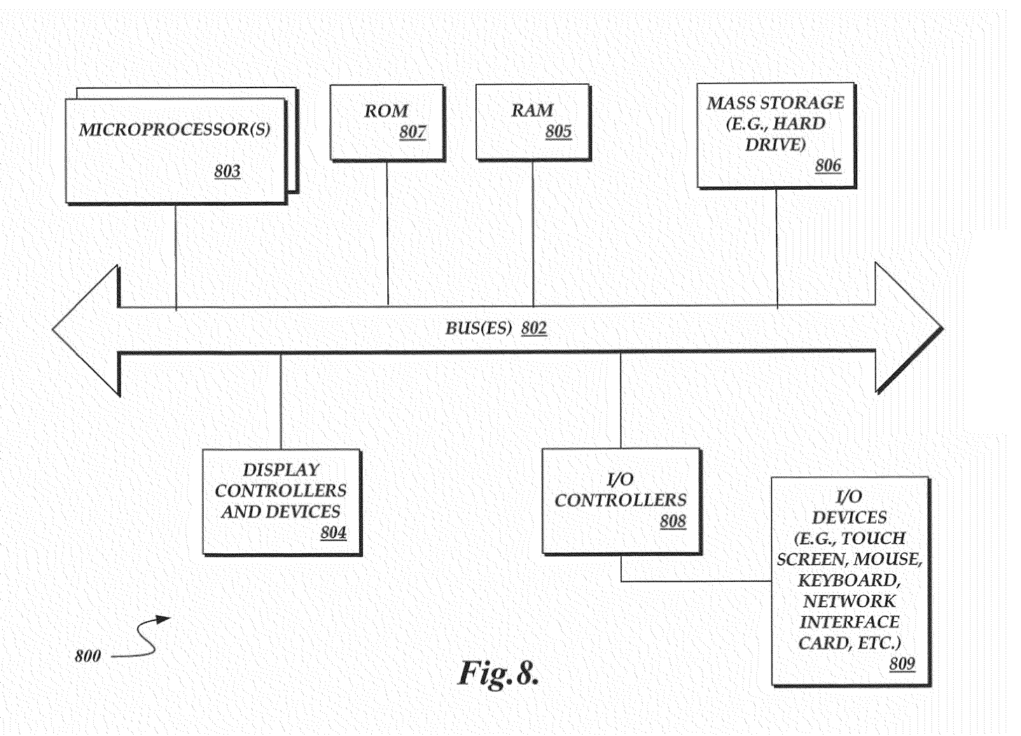

FIG. 8 shows one example of a typical data processing system which may be used with the present invention. Note that while FIG. 8 illustrates the various components of a data processing system, such as a computer system, it is not intended to represent any particular architecture or manner of interconnecting the components as such details are not germane to the present invention. It will also be appreciated that other types of data processing systems which have fewer components than shown or more components than shown in FIG. 8 may also be used with the present invention. The data processing system of FIG. 8 may be a Macintosh computer from Apple Inc. of Cupertino, Calif.

As shown in FIG. 8, the data processing system 801 includes one or more buses 809 which serve to interconnect the various components of the system. One or more processors 803 are coupled to the one or more buses 809 as is known in the art. Memory 805 may be DRAM or non-volatile RAM or may be flash memory or other types of memory. This memory is coupled to the one or more buses 809 using techniques known in the art. The data processing system 801 can also include non-volatile memory 807 which may be a hard disk drive or a flash memory or a magnetic optical drive or magnetic memory or an optical drive or other types of memory systems which maintain data even after power is removed from the system. The non-volatile memory 807 and the memory 805 are both coupled to the one or more buses 809 using known interfaces and connection techniques.

A display controller 811 is coupled to the one or more buses 809 in order to receive display data to be displayed on a display device 813 which can display any one of the user interface features or embodiments described herein. The display device 813 can include an integrated touch input to provide a touch screen. The data processing system 801 can also include one or more input/output (I/O) controllers 815 which provide interfaces for one or more I/O devices, such as one or more mice, touch screens, touch pads, joysticks, and other input devices including those known in the art and output devices (e.g. speakers). The input/output devices 817 are coupled through one or more I/O controllers 815 as is known in the art.

While FIG. 8 shows that the non-volatile memory 807 and the memory 805 are coupled to the one or more buses directly rather than through a network interface, it will be appreciated that the data processing system may utilize a non-volatile memory which is remote from the system, such as a network storage device which is coupled to the data processing system through a network interface such as a modem or Ethernet interface or wireless interface, such as a wireless WiFi transceiver or a wireless cellular telephone transceiver or a combination of such transceivers. As is known in the art, the one or more buses 809 may include one or more bridges or controllers or adapters to interconnect between various buses. In one embodiment, the I/O controller 815 includes a USB adapter for controlling USB peripherals and can control an Ethernet port or a wireless transceiver or combination of wireless transceivers.

It will be apparent from this description that aspects of the present invention may be embodied, at least in part, in software. That is, the techniques and methods described herein may be carried out in a data processing system in response to its processor executing a sequence of instructions contained in a tangible, non-transitory memory such as the memory 805 or the non-volatile memory 807 or a combination of such memories, and each of these memories is a form of a machine readable, tangible storage medium. In various embodiments, hardwired circuitry may be used in combination with software instructions to implement the present invention. Thus the techniques are not limited to any specific combination of hardware circuitry and software nor to any particular source for the instructions executed by the data processing system.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine implemented method to provide a user interface on a device having a display, the method comprising:
receiving in a device having a display an indication that an application is ready to be transferred to the device;
displaying an icon representing the application, the icon moving across the display from a starting location to a destination location to convey a progress of transferring the application to the device;
changing an appearance of the icon moving across the display to simulate flying from the starting location to the destination location, including altering a characteristic of the icon over time, the characteristic including one or more of a position, transparency and size of the icon; and
synchronizing changing the appearance of the icon with the progress of transferring the application to the device.

2. A method as in claim 1, wherein the progress of transferring the application to the device comprises one or more of a commencement, duration and completion of transferring the application to the device.

3. A method as in claim 2, wherein changing the appearance of the icon moving across the display to simulate flying from the starting location to the destination location is synchronized with the commencement, duration and completion of transferring the application to the device.

4. A method as in claim 2, wherein changing the appearance of the icon moving across the display to simulate flying includes changing the appearance of the icon moving across the display to simulate hovering over a location between or including the starting location and the destination location, including altering the characteristic of the position, transparency and size of the icon.

5. A method as in claim 2, wherein changing the appearance of the icon moving across the display upon arrival at the destination location comprises:
moving the icon up and down above the destination location to simulate bouncing; and
gradually lowering the height of moving the icon up and down above the destination location to simulate landing.

6. A method as in claim 5, wherein changing the appearance of the icon moving across the display upon arrival at the destination location is synchronized with the completion of transferring the application to the device.

7. A method as in claim 1, wherein transferring the application to the device includes downloading and installing the application to the device.

8. A machine readable storage medium containing executable instructions which when executed by a system cause the system to perform a method to provide a user interface on a device having a display, the method comprising:
receiving in a device having a display an indication that an application is ready to be transferred to the device;
displaying an icon representing the application, the icon moving across the display from a starting location to a destination location to convey a progress of transferring the application to the device;
changing an appearance of the icon moving across the display to simulate flying from the starting location to the destination location, including altering a characteristic of the icon over time, the characteristic including one or more of a position, transparency and size of the icon; and
synchronizing changing the appearance of the icon with the progress of transferring the application to the device.

9. A medium as in claim 8, wherein the progress of transferring the application to the device comprises one or more of a commencement, duration and completion of transferring the application to the device.

10. A medium as in claim 9, wherein changing the appearance of the icon moving across the display to simulate flying from the starting location to the destination location is synchronized with the commencement, duration and completion of transferring the application to the device.

11. A medium as in claim 8, wherein changing the appearance of the icon moving across the display to simulate flying includes changing the appearance of the icon moving across the display to simulate hovering over a location between or including the starting location and the destination location, including altering the characteristic of the position, transparency and size of the icon.

12. A medium as in claim 8, wherein changing the appearance of the icon moving across the display upon arrival at the destination location comprises:
moving the icon up and down above the destination location to simulate bouncing; and
gradually lowering the height of moving the icon up and down above the destination location to simulate landing.

13. A medium as in claim 12, wherein changing the appearance of the icon moving across the display upon arrival at the destination location is synchronized with the completion of transferring the application to the device.

14. A medium as in claim 8, wherein transferring the application to the device includes downloading and installing the application to the device.

15. A data processing system comprising:
means for receiving an indication that an application is ready to be transferred to a device having a means for displaying a user interface;
means for transferring the application to the device;
means for displaying an icon representing the application on the user interface, including a means for moving the icon across the user interface from a starting location to a destination location, the means for moving representing a status of the means for transferring the application to the device;
means for changing an appearance of the icon while performing the means for moving the icon to simulate flying from the starting location to the destination location, including a means for altering a characteristic of the icon over time, the characteristic including one or more of a position, transparency and size of the icon; and
means for synchronizing changing the appearance of the icon with the status of the means for transferring the application to the device.

16. A system as in claim 15, wherein the status of the means for transferring the application to the device comprises one or more of a commencement, duration and completion of the means for transferring the application to the device.

17. A system as in claim 16, wherein performing the means for changing the appearance of the icon while performing the means for moving the icon to simulate flying from the starting location to the destination location is synchronized with the commencement, duration and completion of the means for transferring the application to the device.

18. A system as in claim 16, wherein the means for changing the appearance of the icon to simulate flying includes a means for changing the appearance of the icon to simulate hovering over a location between or including the starting location and the destination location, including a means for altering one or more characteristics of the icon, the characteristics including the position, transparency and size of the icon.

19. A system as in claim 16, wherein, upon arrival of the icon at the destination location, the means for changing the appearance of the icon further comprises:
a means for moving the icon up and down above the destination location to simulate bouncing; and
a means for gradually lowering the height of moving the icon up and down above the destination location to simulate landing.

20. A system as in claim 19, wherein, upon arrival of the icon at the destination location, the means for changing the appearance of the icon is synchronized with the completion of the means for transferring the application to the device.

21. A system as in claim 16, wherein the means for transferring the application to the device includes a means for downloading and a means for installing the application to the device.

22. A machine implemented method for transferring an application from a server to device having a display, the method comprising:
initiating a transfer of an application from a server to a device in communication with the server, the device having a display configured with a user interface to track a status of the transfer of the application, the user interface including a display of an icon representing the application, the icon moving across the display from a starting location to a destination location to track the status of the transfer of the application to the device;
sending the status of the transfer of the application from the server to the device, the status including one or more of a commencement, duration and completion of the transfer of the application to the device, wherein responsive to receiving the status of the transfer of the application from the server to the device, the device changes an appearance of the icon moving across the display to simulate flying from the starting location to the destination location, including altering a characteristic of the icon in accordance with the status of the transfer of the application from the server to the device, the characteristic including one or more of a position, transparency and size of the icon.

23. A method as in claim 22, wherein initiating the transfer of the application to the device includes initiating downloading and installing the application on the device.
